(19) United States
(12) Patent Application Publication
(10) Pub. No.: US 2023/0225569 A1
(43) Pub. Date: Jul. 20, 2023

(54) PERSONAL CLEANSING DEVICE

(71) Applicant: Peeq Industries, Inc., Omaha, NE (US)

(72) Inventors: Thomas A. Chapman, Omaha, NE (US); Cheryl Chapman, Omaha, NE (US); Chris Wolfe, Omaha, NE (US); Jamie Wolfe, Omaha, NE (US); Scott Bragg, Omaha, NE (US); Razia Aziz-Seible, Omaha, NE (US); Richard Morris, Omaha, NE (US); Alan Tipp, Elkhorn, NE (US); David Tipp, Chandler, AZ (US); Curtis D. Gridley, Wichita, KS (US); Tracy A. Hoover, Wichita, KS (US)

(21) Appl. No.: 17/575,935

(22) Filed: Jan. 14, 2022

(51) Int. Cl. A47K 7/04; B08B 1/00

(52) U.S. Cl. CPC A47K 7/043; B08B 1/001

(57) ABSTRACT

A personal cleansing device may include, but is not limited to: a body portion; an electric motor disposed within the body portion; control circuitry configured for control of operation of the electric motor; and a recess defined in the body portion and configured to receive at least one sponge insert.

### FIELD OF THE INVENTION

The invention relates generally to the field of personal cleansing, namely, a device for skin cleansing. Specifically, the present invention may be employed for the cleansing of facial surfaces around the eyes to remove makeup or other applied skin care products, naturally produced oils, and the like, so as to prevent buildup in meibomian glands which may result in various undesired conditions including blepharitis.

### BRIEF DESCRIPTION OF THE DRAWINGS

The numerous advantages of the disclosure may be better understood by those skilled in the art by reference to the accompanying figures in which:

FIG. 1 shows an exploded view of components of a personal cleaning device;

FIG. 2 shows electrical components of a personal cleaning device;

FIG. 3 shows a personal cleaning device including a sponge insert;

FIG. 4 shows a personal cleaning device including a sponge insert;

FIG. 5 shows a personal cleaning device including a sponge insert;

FIG. 6 shows a personal cleaning device including a sponge insert; and

FIG. 7 shows a personal cleaning device including a sponge insert.

### DETAILED DESCRIPTION

Reference will now be made in detail to various embodiments of the invention, examples of which are illustrated in the accompanying drawings. While the invention will be described in conjunction with the following embodiments, it will be understood that the descriptions are not intended to limit the invention to these embodiments. On the contrary, the invention is intended to cover alternatives, modifications and equivalents that may be included within the spirit and scope of the invention. Furthermore, in the following detailed description, numerous specific details are set forth in order to provide a thorough understanding of the present invention. However, it will be readily apparent to one skilled in the art that the present invention may be practiced without these specific details. In other instances, well-known methods, procedures, components, and materials have not been described in detail so as not to unnecessarily obscure aspects of the present invention.

The technical proposal(s) of embodiments of the present invention will be fully and clearly described in conjunction with the drawings in the following embodiments. It will be understood that the descriptions are not intended to limit the invention to these embodiments. Based on the described embodiments of the present invention, other embodiments can be obtained by one skilled in the art without creative contribution and are in the scope of legal protection given to the present invention.

Furthermore, all characteristics, measures or processes disclosed in this document, except characteristics and/or processes that are mutually exclusive, can be combined in any manner and in any combination possible. Any characteristic disclosed in the present specification, claims, Abstract and Figures can be replaced by other equivalent characteristics or characteristics with similar objectives, purposes and/or functions, unless specified otherwise.

The advantages of the present invention will become readily apparent from the detailed description of various embodiments below.

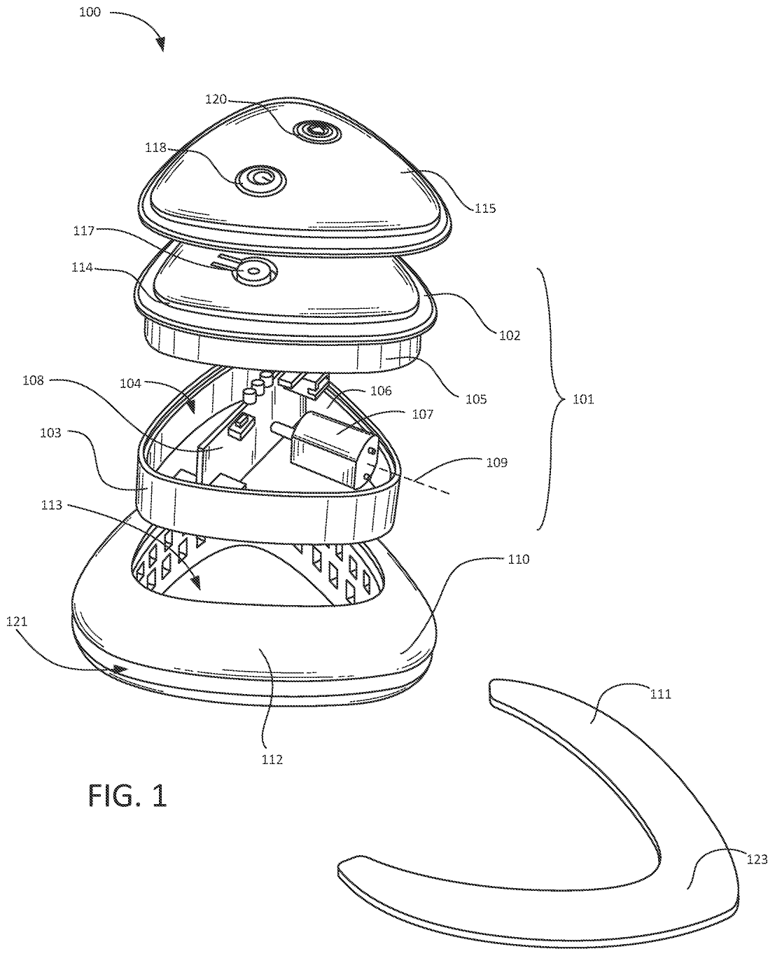

Referring to FIG. 1, a personal cleaning device 100 is shown. The device 100 may include an internal housing 101 having a top portion 102 and a bottom portion 103. The top portion 102 and/or the bottom portion 103 may be constructed of a rigid or semi-rigid plastic material (e.g., injection-molded or 3D printed thermoplastics such as Acrylonitrile Butadiene Styrene (ABS), Polyethylene terephthalate (PET), Polypropylene (PP), and the like). The top portion 102 and/or the bottom portion 103 may define a recess 104 and may be coupled to form the housing 101. In one embodiment, the top portion 102 may define a flanged portion 105 which may be configured to be received within and frictionally engage a perimeter wall 106 of the bottom portion 103 so as to couple the top portion 102 and the bottom portion 103.

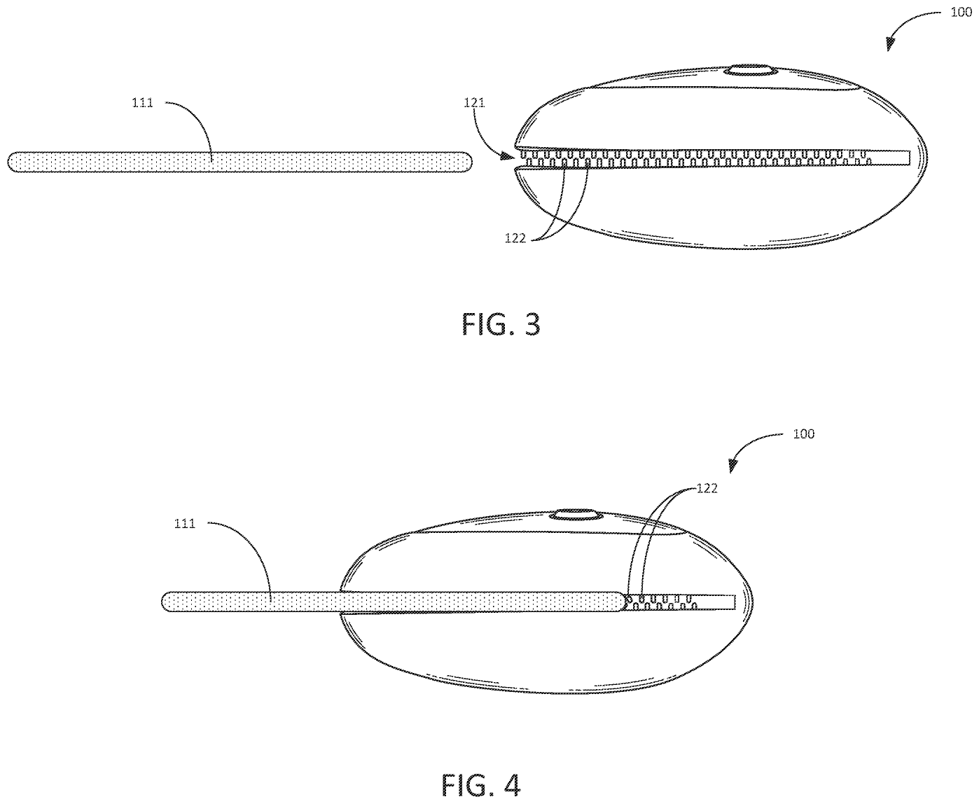

The device 100 may further include an electric motor 107 operably coupled to a control circuitry board 108 and at least one battery (not shown). The electric motor 107 may include a vibrational component (not shown), the movement of which is configured to induce vibration in the device 100 as a whole. For example, the vibrational component may include a mass coupled to a rotating drive shaft defining an axis 109 of the electric motor 107. The mass may be asymmetrically distributed around the axis 109 such that rotation of the vibrational component about the axis 109 may cause vibration of the device 100. Referring to FIG. 3, the axis 109 may be oriented such that it points generally in a direction of a front corner 110 of the device 100 configured to receive a sponge insert 111, as will be described further below. In other embodiments, the vibrational component may be any other electrically powered rotational or oscillating structure configured to induce vibration in the device 100. The vibrational component may cause vibration of the device 100 at sonic frequencies (e.g., above 200 Hz) up to ultrasonic frequencies (e.g., at or above 1.6 MHz). Rotational vibration induced via the vibrational component around the axis 109 may serve to optimize cleansing using the front corner 110 as high-frequency, circular motion of the front corner 110 may be focused on a particular surface (e.g. a facial surface) to be cleaned.

The device 100 may include an external body 112. The external body 112 may be constructed of a semi-rigid or elastomeric material (e.g., silicone). The external body 112 may include an aperture 113 configured to receive and frictionally retain the bottom portion 103 of the housing 101. Further, the top portion 102 of the housing 101 may include a projecting portion 114 which may be received into and be frictionally retained within a recess defined by a cover 115.

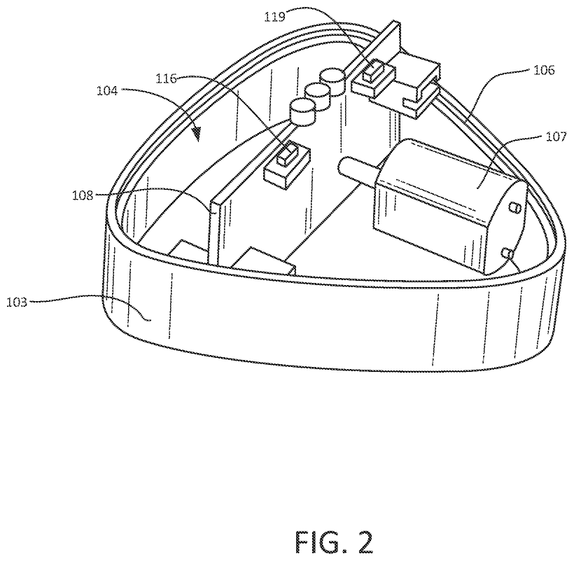

Referring to FIG. 2, the control circuitry board 108 may include one or more user interface components (e.g., one or more switches or buttons) configured to allow user control of the activation and/or speed of vibration of the device 100 induced by the electric motor 107. For example, the control circuitry board 108 may be coupled to a power switch 116. Referring again to FIG. 1, the top portion 102 of the housing 101 may include a corresponding actuatable button 117 formed in a top surface of the top portion 102 of the housing 101. Additionally, a pressure pad 118 may be formed in a top surface of the cover 115. Upon an application of pressure to the pressure pad 118 by a user, a corresponding pressure may be applied to the button 117 which may then contact the power switch 116 thereby activating the electric motor 107.

Similarly, referring again to FIG. 2, the control circuitry board 108 may include a speed control switch 119. The top portion 102 of the housing 101 may include a corresponding actuatable button (not shown) formed in a top surface of the top portion 102 of the housing 101. Additionally, a pressure pad 120 may be formed in the top surface of the cover 115. Upon an application of pressure to the pressure pad 120 by a user, a corresponding pressure may be applied to the button which may then contact the speed control switch 119 thereby changing a vibrational speed of the electric motor 107. Subsequent activations of the speed control switch 119 may progressively change the vibrational speed of the electric motor 107, for example, from a high speed to a medium speed to a low speed then returning to the high speed. Any number of different speeds and speed change increments may be employed without departing from the scope of the present disclosures.

As noted above, the device 100 may be configured to receive a sponge insert 111. Referring to FIGS. 1 and 3-6, the external body 112 may define a recess 121 configured to receive a portion of the sponge insert 111. For example, the recess 121 may be configured as a channel in the external body 112 which passes from a first rear corner of the external body 112, around the front corner 110 of the external body 112, to a right rear corner of the external body 112. As shown in FIG. 1, the sponge insert 111 may have a U-shape or V-shape corresponding to a perimeter of the device 100 into which the recess 121 is formed. However, other shapes for the perimeter of the device 100, recess 121 and sponge insert 111 (e.g., rectilinear, rounded, enclosed circular, etc.) may be employed without departing from the scope of the present disclosures.

Referring to FIGS. 3-4, one or more flexible fibrous projections 122 may extend from the top and/or bottom interior surface of the recess 121. Referring to FIGS. 4-7, progressive insertion of the sponge insert 111 into the recess 121 of the external body 112 is shown. As shown in FIG. 4, as the sponge insert 111 is inserted into the recess 121, the fibrous projections 122 may flex to apply additional pressure the surface of the sponge insert 111 and/or interact with the pores of the sponge insert 111 so as to secure the sponge insert 111 within the recess 121.

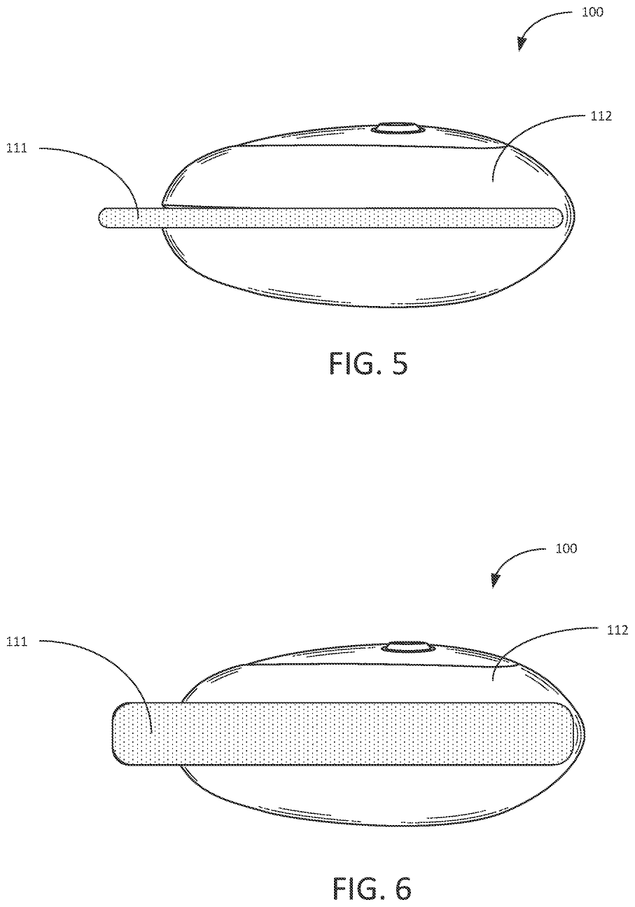

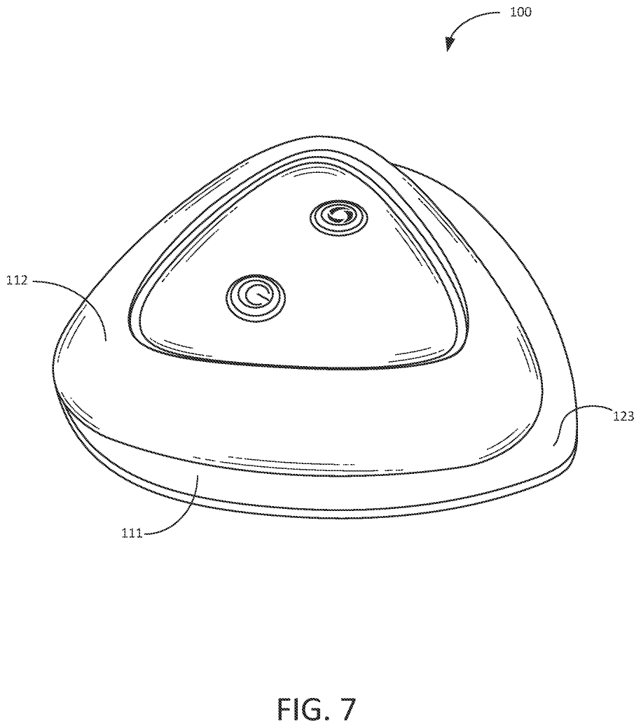

As shown in FIGS. 5 and 7, upon full insertion of the sponge insert 111 into the recess 121, a cleansing solution (e.g., a tea tree based natural cleanser), may be applied to the sponge insert 111. As shown in FIG. 6, the sponge insert 111 may be constructed of any biocompatible material that will expand upon an application of a liquid. For example, the sponge insert 111 may include products such as those marketed by Absorene Manufacturing Company, Inc. of St. Louis, Mo. Such expansion of the sponge insert 111 may serve to further secure the sponge insert 111 within the recess 121 and provide additional working surface area of the sponge insert 111 to be used when a user performs personal cleansing. Further, as noted above, the sponge insert 111 may have a form factor (e.g., a rounded V-shape) which provides at least one corner 123 corresponding to the front corner 110 of the external body 112. Such a form factor provides a perimeter shape of the sponge insert 111 which allows a user to bring the device 100 into contact with the varying surfaces of a user's face. Specifically, the sponge insert 111 may be dimensioned to have a rounded corner having a sufficiently small profile (e.g., as a function of the pointedness of the edges of the sponge insert 111) to effectively contact a user's meibomian glands, nasal sidewall, nasal sura-alar crease, medial and lateral canthus, and eyelids.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed:

1. A personal cleansing device comprising:
a body portion;
an electric motor disposed within the body portion;
control circuitry configured for control of operation of the electric motor; and
a recess defined in the body portion and configured to receive at least one sponge insert.

2. The personal cleansing device of claim 1, wherein the body portion includes:
an internal housing portion configured to contain the electric motor; and
an external body portion disposed at least partially around the internal housing portion.

3. The personal cleansing device of claim 1, wherein the electric motor includes:
a vibrating component configured to induce vibration of the personal cleansing device.

4. The personal cleansing device of claim 3, wherein the vibrating component includes:
a mass asymmetrically distributed around a drive shaft of the electric motor.

5. The personal cleansing device of claim 1, wherein the control circuitry includes:
a user-activatable electric motor power control interface.

6. The personal cleansing device of claim 1, wherein the control circuitry includes:
a user-activatable electric motor speed control interface.

7. The personal cleansing device of claim 1, further comprising:
one or more fibers projecting from one or more surfaces internal to the recess defined in the body portion.

8. The personal cleansing device of claim 1, further comprising:
the sponge insert.
